(19) United States
(12) Patent Application Publication
(10) Pub. No.: US 2021/0201534 A1
(43) Pub. Date: Jul. 1, 2021

(54) METHOD AND DEVICE FOR PARAMETER PROCESSING FOR CAMERA AND IMAGE PROCESSING DEVICE

(71) Applicant: SZ DJI TECHNOLOGY CO., LTD., Shenzhen (CN)

(72) Inventors: Jiabin LIANG, Shenzhen (CN); Minglei ZHANG, Shenzhen (CN)

(21) Appl. No.: 17/200,735

(22) Filed: Mar. 12, 2021

Related U.S. Application Data
(63) Continuation of application No. PCT/CN2018/107417, filed on Sep. 25, 2018.

(51) Int. Cl. G06T 7/80; G01C 11/02; G01C 11/34; H04N 5/232; H04N 7/18

(52) U.S. Cl. CPC G06T 7/80; G01C 11/02; G06T 2207/10032; H04N 5/23299; H04N 7/18; G01C 11/34

(57) ABSTRACT

Embodiments of the present disclosure provide a method for processing camera parameters. The method includes obtaining an environmental image set, the environmental image set including a first type image and two or more second type images, a direction of a light sensing element of the camera capturing the first type image being different from the direction of the light sensing element of the camera capturing the two or more second type images; calculating internal parameters of the camera based on a plurality of target object image points on the first type image and the two or more second type images in the environmental image set. The camera is mounted on an aircraft. The camera is configured to capture a plurality of environmental images of an environment below the aircraft. The calculated internal parameters of the camera include an image position of the principal point of the camera.

### CROSS-REFERENCE TO RELATED APPLICATION

This application is a continuation of International Application No. PCT/CN2018/107417, filed on Sep. 25, 2018, the entire content of which is incorporated herein by reference.

### TECHNICAL FIELD

The present disclosure relates to the technical field of communication technology and, more specifically, to a method and device for parameter processing for a camera, and an image processing device.

### BACKGROUND

An unmanned aerial vehicle (UAV) is an unmanned aircraft operated by a radio remote control device and an onboard program control device. UAVs were originally designed to be used in war. With the development of the information age, more advanced information processing and communication technologies are implemented in UAVs, as such, the field of UAV applications continues to increase. At present, UAVs are used in many fields such as in aerial photography, mini-selfie, news reports, power inspections, and movie and television filming.

UAVs can be used in the field of aerial photography. Based on the principle of photogrammetry, a large number of aerial images obtained by a single UAV can be processed into orthophotos with measurable features. The main principle of making an orthophoto is to use an image processing algorithm to calculate the imaging attitude of each photo taken by the UAV, and then use an image fusion algorithm to fuse the photos into an orthophoto. When using the image processing algorithm to calculate the imaging attitude of each photo, one of the calculation parameters include the camera's internal parameters.

Therefore, it is important to determine the camera's internal parameters in order to better realize functions such as the shooting and production of orthophotos.

### SUMMARY

One aspect of the present disclosure provides a method for processing camera parameters. The method includes obtaining an environmental image set, the environmental image set including a first type image and two or more second type images, a direction of a light sensing element of the camera capturing the first type image being different from the direction of the light sensing element of the camera capturing the two or more second type images; calculating internal parameters of the camera based on a plurality of target object image points on the first type image and the two or more second type images in the environmental image set. The camera is mounted on an aircraft. The camera is configured to capture a plurality of environmental images of an environment below the aircraft. The calculated internal parameters of the camera include an image position of the principal point of the camera.

Another aspect of the present disclosure provides an image processing device. The device includes a processor; and a memory storing program instructions that, when being executed by the processor, cause the processor to obtain an environmental image set, the environmental image set including a first type image and two or more second type images, a direction of a light sensing element of the camera capturing the first type image being different from the direction of the light sensing element of the camera capturing the two or more second type images; calculate internal parameters of the camera based on a plurality of target object image points on the first type image and the two or more second type images in the environmental image set. The image processing device is configured to process the parameters of the camera. The camera is mounted on the aircraft and configured to capture a plurality of environmental images on an environment below the aircraft. The calculated internal parameters include a focal length of the camera.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1A is a diagram of a method for processing parameters of a camera according to an embodiment of the present disclosure.

FIG. 1B is a top view of a flight path of an aircraft according to an embodiment of the present disclosure.

FIG. 2 is a flowchart of a method for processing parameters of a camera according to an embodiment of the present disclosure.

FIG. 3A is a schematic diagram of calculating a principal point of a camera according to an embodiment of the present disclosure.

FIG. 3B is another schematic diagram of calculating the principal point of a camera according to an embodiment of the present disclosure.

FIG. 4 is a flowchart of another method for processing parameters of a camera according to an embodiment of the present disclosure.

FIG. 5A is a side view of a camera with a shooting angle as a reference angle according to an embodiment of the present disclosure.

FIG. 5B is a top view of a camera with a shooting angle as the reference angle according to an embodiment of the present disclosure.

FIG. 6A is a schematic diagram of calculating a focal length of a camera according to an embodiment of the present disclosure.

FIG. 6B is another schematic diagram of calculating the focal length of a camera according to an embodiment of the present disclosure.

FIG. 7 is a schematic structural diagram of a camera parameter processing device according to an embodiment of the present disclosure.

FIG. 8 is a schematic structural diagram of another camera parameter processing device according to an embodiment of the present disclosure

FIG. 9 is a schematic structural diagram of an image processing device according to an embodiment of the present disclosure.

FIG. 10 is a schematic structural diagram of another image processing device according to an embodiment of the present disclosure.

### DETAILED DESCRIPTION OF THE EMBODIMENTS

In order to make the objectives, technical solutions, and advantages of the present disclosure clearer, the technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

Embodiments of the present disclosure provides a parameter processing method for a camera. The camera can be mounted on an aircraft, and the camera can be used to capture environmental images of the environment below the aircraft. The parameter processing method can be executed by an image processing device. In some embodiments, the image processing device can be mounted on an aircraft, or the image processing device can also be a ground device connected to eh aircraft by wireless or other means. The image processing device may refer to a smart device capable of processing a plurality of environmental images captured by a camera to generate an orthophoto, or the image processing device may also refer to a camera with image processing functions.

By using the parameter processing method of the embodiments of the present disclosure, accurate camera internal parameters can be obtained. Based on the internal parameters of the camera and the environmental images captured by the camera, a higher-precision orthophoto can be generated, thereby improving the accuracy of the digital surface model generated based on the orthophotos.

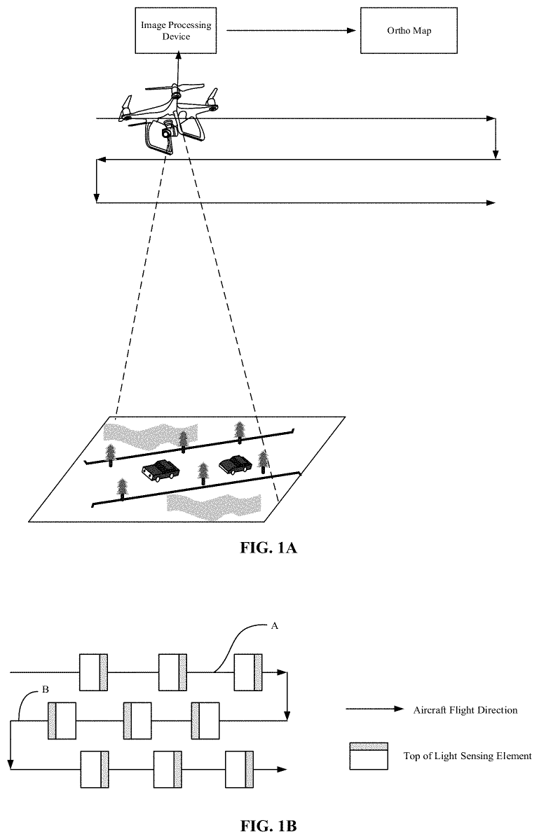

In one embodiment, referring to FIG. 1A, which is a schematic diagram of using an aircraft to collect environmental images and generating orthophotos according to an embodiment of the present disclosure. As shown in FIG. 1, when collecting the plurality of images for generating the orthophotos, the aircraft needs to fly on a predetermined path over the designated area and capture images at a certain overlap rate. Assume that the predetermined path is a zigzag path, FIG. 1B is a top view of the aircraft flying along the zigzag path. The image processing device can process a plurality of environmental images captured by the camera to obtain orthophotos. The image processing device can calculate the imaging attitude of each environmental image, and use an image fusion algorithm to fuse the plurality of environmental images into an orthophoto that can be used to measure geographic information.

In some embodiments, when calculating the imaging attitude of each environmental image, the camera's internal parameters and the geographic coordinate system when the camera is capturing each environmental image may need to be obtained. In some embodiments, the internal parameters of the camera may be determined by the image processing device using an aerial triangulation algorithm to calculate the environmental images captured by the camera, or determined the image processing device using a structure-from-motion (SFM) algorithm to calculate the environmental images captured by the camera, or obtained by using other algorithms based on iterative optimization to process the environmental images captured by the camera. The geographic coordinate system may refer to an absolute geographic coordinate system. Since the aircraft used to collect and generate the environmental images of the orthophotos may be equipped with a high-precision real-time kinematic (RTK) module. As such, each environmental image captured by the aircraft may record the specific geographic position of the aircraft. The absolute geographic coordinate system can be obtained based on the geographic positioned recorded in the environmental image (the aircraft equipped with the RFK module can be referred to as a phase-free aircraft). In one embodiment, the internal parameters of the camera may include a focal length of the camera and/or an image position of a principal point of the camera. The image position of the principal point may refer to the intersection of the main optical axis of the camera lens and the image plane (that is, the light sensing element). When the light sensing element is fixed, the main optical axis of the camera can be determined to determine the image position of the principal point. The focal length may refer to the distance between the optical center and the light sensing element. When the light sensing element is fixed, the focal length of the camera can be obtained by determining the optical center.

In one embodiment, to obtain accurate camera internal parameters, and accurately calculate the imaging attitude of each environmental image, thereby improving the accuracy of the orthophoto. In the schematic diagram shown in FIG. 1A, when the aircraft is flying along the zigzag path, the camera can be controlled by controlling the gimbal or using other methods when shooting the environmental images below the aircraft, such that the direction of the light sensing element in the camera will be constantly changing. That is, when the aircraft flies along the zigzag path to collect environmental images for generating the orthophotos, it is needed to ensure that the collected environmental images are captured by the camera with the light sensing element in different directions.

Referring to FIG. 2, which is a flowchart of a method for processing parameters of a camera according to an embodiment of the present disclosure. The method will be described in detail below.

S201, obtaining an environmental image set, the environmental image set including a first type image and at least two second type images where the direction of the light sensing element used when the camera captures the first type image and the second type image is different.

S202, obtaining the camera internal parameters through calculation based on a plurality of target object image points on the first type image and the second type image in the environmental image set.

By using the parameter processing method shown in FIG. 2, the image position of the principal point of the camera can be calculated, and then based on the image position of the principal point of the camera and the geographic positions in the plurality of environmental images (or it can be referred to as the absolute geographic coordinate system), a plurality of environmental images can be made into a measurable orthophoto.

In the process of obtaining the image position of the principal point of the camera, an environmental image set needs to be obtained first. The environmental image set may include a first type image and at least two second type images. The first type image and the second type image may both be images of the environments below the aircraft captured by the camera, and the direction of the light sensing element used when the camera captures the first type image and the second type image may be different. For example, as shown in FIG. 1B, when the aircraft is flying on adjacent path segments, namely path segment A and path segment B, the direction above the light sensing element is different. At this time, the environmental images of the environment below the aircraft captured by the camera can be referred to as the first type image and the second type image, respectively.

In one embodiment, the first type image and the second type image can be regarded as environmental images captured when the light sensing element in the camera is in different directions. As shown in FIG. 1B, when the aircraft is flying along the path A, the top of the light sensing element can be the same as the flying direction of the aircraft. At this time, the environmental image captured by the camera can be referred to as the first type image. When the aircraft turns its nose to fly along the path B, the direction of the light sensing element may also change. The light sensing element may be adjusted by 180° in the horizontal direction, such that the upper part of the light sensing element may become the same as the flight direction of the aircraft on the path B as shown in FIG. 1B. Alternatively, the light sensing element in the horizontal direction may be adjusted to other angles, such as 90°, 120°, etc., such that the upper part of the light sensing element and the path B may form a certain angle. At this time, the environmental image captured by the camera may be referred to as the second type image.

When setting the flight route of the aircraft, on one hand, considering the related shooting requirements of the orthophotos, it may be needed to ensure that the environmental images captured on some different segments of the flight tour have a certain overlap area. On the other hand, considering the forward obstacle avoidance generally adopted by the aircraft obstacle avoidance function, therefore, it may be needed to ensure that that aircraft's nose direction is the same or substantially the same as the flight direction, and at least ensure that the angle between the flight direction and the nose direction is within a predetermined angle threshold. That is, the obstacle identification module disposed on the aircraft is generally disposed at the nose of the aircraft to keep the aircraft flying along the path with the nose in the front and the tail in the back, and the obstacle identification module can be configured to identity and avoid obstacles in time to ensure the safety of the aircraft. This can not only meet the related imaging requirements of the orthophoto, but can also ensure the realization of the aircraft's obstacle avoidance function. The flight path may be, for example, the path A of FIG. 1B.

In one embodiment, the processor at S201 indicates that before calculating the image position of the principal point of the camera, at least three environmental images captured by the light sensing element in different directions need to be obtained first. In other embodiments, the image processing device may obtain all the first type images and the second type images captured by the light sensing element in different directions as a basis to calculate the internal parameters of the camera.

In one embodiment, when selecting the first type image and the second type image, it may be needed to ensure that the first type image and the second type image include at least one object that is the same. For example, there is a bridge in the environment below the aircraft, and the selected first type image and the second type image both include the bridge. In one embodiment, the method for selecting the first type image and the second type image may include obtaining all the first type environmental images captured by the camera when the light sensing element is in a first direction, and obtaining all the second type environmental images captured by the camera when the light sensing element is in a second direction; selecting at least one image including a target object from the first type environmental images as the first type image, and selecting at least two images including the target object form the second type environmental images as the second type images. Alternatively, at least two images including target object may be selected from the first type environmental images as the first type images, and at least one image including the target object may be selected from the second type environmental images as the second type image.

In one embodiment, in the parameter processing method shown in FIG. 2, the camera may be mounted on the aircraft via a gimbal. During the flight of the aircraft, the rotation of the gimbal can be controlled such that the camera can use different light sensing element orientations to capture environmental images before and after the rotation of the gimbal.

In some embodiments, controlling the gimbal rotation may be controlling the gimbal rotation when the aircraft flies to a target waypoint on a predetermined flight path. That is, a plurality of target waypoints may be set on the aircraft's predetermined flight path in advance. When the aircraft flies to the target waypoint, the gimbal can be controlled to rotate to ensure that the camera uses different light sensing element orientations to captures environmental images below the aircraft before and after the target waypoint.

In another embodiment, controlling the gimbal rotation may also be controlling the gimbal rotation on a predetermined flight path based on a predetermined time interval. In some embodiments, the time interval may be a regular time interval, for example, the gap between each time interval may form a geometric series, or the gap between each time interval may form an arithmetic series. Alternatively, each time interval may be the same, for example, each time interval may be 10 minutes. That is, the aircraft may be control the gimbal to rotate every 10 minutes. Further, the time interval may be an irregular, random time interval. For example, the first time interval may be 5 minutes, the second time interval may be 8 minutes, and the third time interval may be 2 minutes.

In one embodiment, the gimbal may be controlled to rotate on the target waypoints of the predetermined flight path. In some embodiments, the target waypoints may include a plurality of designated waypoints on the predetermined flight path, or the target waypoints may include a plurality of waypoints determined from the predetermined flight path based on a predetermined confirmation rule. In one embodiment, the target waypoints including the designated waypoints on the predetermined flight path may referred to certain points randomly selected as the target waypoints on the predetermined flight path. In one embodiment, if the target waypoints includes a plurality of points determined from the predetermined flight path based on the predetermined confirmation rule, determining the target waypoints from the predetermined flight path based on the predetermined confirmation rule may include determining the target waypoints from the predetermined flight path based on a predetermined distance interval. In some embodiments, the distance interval may be a regular distance interval or an irregular distance interval. For example, assume that each distance interval is the same at 500 meters, a target waypoint can be set every 500 meters on the predetermined flight path. Assume that the distance interval is 500 meters, 2000 meters, and 800 meters in sequence, the waypoints can be set at 500 meters, 2500 meters, and 3300 meters in sequence on the predetermined flight path.

In some embodiments, the confirmation rule for determining the target waypoints may be determined based on the environment below the aircraft, or the confirmation rule may be determined based on the performance and flight state of the aircraft. In other embodiments, the confirmation rule may also be determined based on other factors, which are not specifically limited in the embodiments of the present disclosure.

In some embodiments, the rule for controlling the rotation of the gimbal in the embodiments of the present disclosure may be to ensure that the top of the camera's light sensing element is perpendicular to the flight direction of the aircraft (FIG. 1B). Alternatively, in other embodiments, the adjustment rule may also be to ensure that the top of the camera's light sensing element and the flight direction of the aircraft form a predetermined angle, such as 90°, 120°, etc. the adjusted included angle can be set based on actual needs, which is not limited in the embodiments of the present disclosure.

For example, assume that in the schematic diagram shown in FIG. 1A, the aircraft in this embodiment of the present disclosure can fly based on a predetermined flight path, such as a zigzag pattern, when collecting the environmental images. When it is detected that the aircraft has flew to the target waypoint on the flight path or the aircraft has been flying for a predetermined time interval, the direction of the light sensing element of the camera may be adjusted by controlling the rotation of the gimbal.

In the parameter processing method of a camera shown in FIG. 2, after the image processing device obtains the environmental image set from the environmental images captured by the camera, in the process at S202, the internal parameters of the camera can be calculated based on the target object image points on the first type images and the second type images in the environmental image set. In some embodiments, the target object image points may be the imaging points of the target object in the first type image and the second type image in the environmental image set.

In some embodiments, the target object image point on the first type image and the target object image point on the second type image may be understood as a pair of related target object image points. The related target object image points may be for a certain target object, and the target object may be captured in both the first type image and the second type image captured by the camera. The target object can have corresponding target object image points in the first type image and the second type image. The target object image point corresponding to the target object on the first type image and the target object image corresponding to the target object on the second type image may be referred to as a pair of related target object image points.

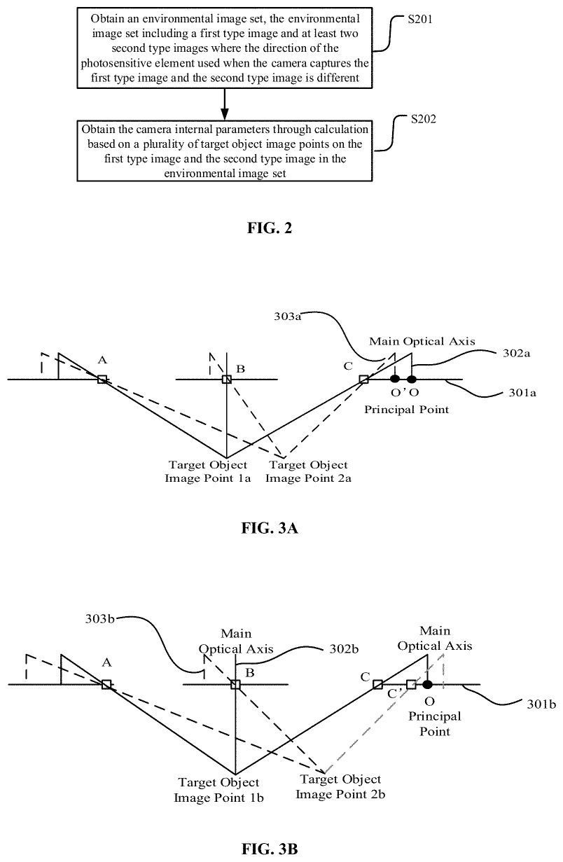

In some embodiments, the image processing device may use an aerial triangulation algorithm to calculate the internal parameters of the camera. The aerial triangulation algorithm mainly uses the inherent collective characteristics of the various environmental images captured by the aircraft to obtain a small number of field control points, and the control points can be encrypted indoors to obtain the elevation and plane position of the encrypted points. That is, using continuously captured aerial images with a certain overlap, and based on a small number of field control points to establish a path model or a regional network model corresponding to the field by photogrammetry to obtain the plane coordinates and elevation of the encrypted points, which is mainly used to surveying and mapping. In the embodiments of the present disclosure, the aerial triangulation algorithm can be used to calculate the internal parameters of the camera, that is, to determine the internal parameters of the camera self-calibrated by the aerial triangulation algorithm. Subsequently, based on the camera's internal parameters and the overlapping parts of each environmental images, the imaging attitude of each environmental image can be calculated. In other embodiments, the image processing device may also use the SFM algorithm or other algorithms based on iterative optimization to calculate the internal parameters of the camera. In the embodiments of the present disclosure, the aerial triangulation algorithm is used to calculate the internal parameters of the camera as an example. The principle of calculating the internal parameters of the camera is described by using the method of processing the camera parameters described in FIG. 2 or FIG. 3. For the calculation principle of other algorithms, reference may be made to the calculation principle of the aerial triangulation algorithms, which is not described in detail in the embodiments of the present disclosure.

In the embodiments of the present disclosure, when the aircraft is flying on the predetermined flight path, the gimbal can be controlled to rotate to ensure that the direction of the light sensing element is constantly changing, and then the first type image and the second type image captured by the camera's light sensing element in different directions can be obtained. Further, based on the target object image points on the first type image and the second type image, when the aerial triangulation algorithm is used to calculate the internal parameters of the camera, the main optical axis of the camera can be accurately calculated, and the image position of the principal point in the camera can be determined based on the target main optical axis and the light sensing element.

If the aircraft is flying based on the predetermined flight path and the direction of the light sensing element is kept unchanged, at this time, the obtained environmental image set may include only the first type image or the second type image. At this time, based on the target object image point on the first type image or the second type image, when using the aerial triangulation algorithm to calculate the camera internal parameters, a plurality of optical axes may be obtained, and it is difficult to accurately determine which main optical axis is the target main optical axis. Therefore, the image position of the principal point of the camera cannot be accurately determined, and the inaccurate internal parameters of the camera may cause errors in the orthophoto generated at the end.

In other words, when the aircraft flies along the predetermined path to collect environmental images, if the direction of the light sensing element of the camera on all the path segments of the predetermined path is uniformly oriented and at a uniform height, when calculating the image position of the principal point of the camera, a plurality of image positions of the principal point of the camera may be obtained. As such, the calculated images attitude of each environmental image may be deviated in the horizontal direction, which can lead to systematic errors in the absolute accuracy of the orthophoto in the horizontal direction.

Referring to FIG. 3A, which is a schematic diagram of calculating the image position of the principal point of the camera when the direction of the light sensing element is unchanged when the aircraft is flying on a predetermined flight path according to an embodiment of the present disclosure. FIG. 3A includes a light sensing element 301a in the camera, respective target object image points A and B on the second type image, a target object image point C on the first type image, the second type image and the first type image being environmental images captured in the same direction by the light sensing element of the camera. Assume that 302a is the main optical axis of the camera, in the second type image and the first type image, there may be a light path passing through the main optical axis and the target object image point, and converging at an object point 1a. That is, when the main optical axis is 302a, there may be an object point such that the projection just overlaps with the three target object image points, which conforms to the projection model of the camera. The principal point of the image may be the intersection of the main optical axis of the camera and the light sensing element. Therefore, assume that 302a is the main optical axis, an image principal point O may be determined.

If it is assumed that the main optical axis is 303a, it can be seen from FIG. 3A that there is still an object point 2a in the environment below, such that the light paths passing through the main optical axis 303a and the three target object image points can intersect as this point. This situation also conforms to the projection model of the camera, therefore, based on the main optical axis 303a, it can be determined that the principal point of the camera is O′. It can be seen that, in FIG. 3A, during the flight of the aircraft on the predetermined flight path, if the direction of the light sensing element remains unchanged, based on the target object image points on the first type image and the second type image, at least two image positions of the principal point of the camera can be calculated. The image processing device cannot determine which of the at least two image positions of the principal point to select as the correct image position of the principal point of the camera. If the wrong image position of the principal point is selected as the internal parameter of the camera, the resulting orthophoto will be offset in the horizontal direction.

FIG. 3B is a schematic diagram of calculating the image position of the principal point of the camera when the direction of the light sensing element changes when an aircraft is flying on a predetermined flight path according to an embodiment of the present disclosure. In FIG. 3B, 301b is the light sensing element in the camera, A and B are the target object image points of the second type images, and C is the target object image point of the first type image, the second type image and the first type image being environmental images captured by the camera when the direction of the light sensing element is different. In FIG. 3B, if the main optical axis is assumed to be 302b, the three optical paths passing through the main optical axis and the three target object image points can be converged at an object point 1b, which conforms to the projection model of the camera. At this time, the image position of the principal point determined by the main optical axis 302b and the light sensing element is O. Of the main optical axis is assumed to be 303b, it can be seen from FIG. 3B that the optical path passing through the target object image point on the two second type images and the main optical axis 303b intersects at an object point 2b. In this case, if the object point 2b is projected onto the first type image, the target object image point corresponding to the object point 2b on the first type image is C′ instead of C, which does not conform to the projection model of the camera, which means that the main optical axis at this time is incorrect. Therefore, it can be seen that the main optical axis 302b can be uniquely determined in FIG. 3B, and the image position O of the principal point determined based on the main optical axis 302b is the correct internal parameter of the camera.

By using the parameter processing method for the camera provided in the embodiments of the present disclosure, that is, adjusting the direction of the light sensing element when the camera captures environmental images when the aircraft is flying on a predetermined flight path, the image position of the principal point of the camera can be calculated more accurately, which improves the accuracy of the orthophoto in the horizontal direction.

In the embodiment shown in FIG. 2, the first type image and at least two second type image can be selected from the environmental images captured by the camera to form an environment image set, where the direction of the light sensing element used by the camera when shooting the first type image and the second type image may be different. After the environmental image set is obtained, the image position of the principal point of the camera can be calculated based on the target object image points on the first type image and the second type image in the environmental image set. Since the first type image and the second type image are captured in different directions of the light sensing element, the situation of obtaining a plurality of image positions of the principal point can be avoided, and a more accurate image position of the principal point of the camera can be obtained, thereby improving the accuracy of the orthophoto in the horizontal direction.

The parameter processing method for the camera shown in FIG. 2 can be used to improve the accuracy of the orthophoto in the horizontal direction. In practical applications, in order to make the orthophoto absolute accurate, not only the accuracy of the orthophoto in the horizontal direction needs to be ensured, but the elevation accuracy of the orthophoto also needs to be ensured.

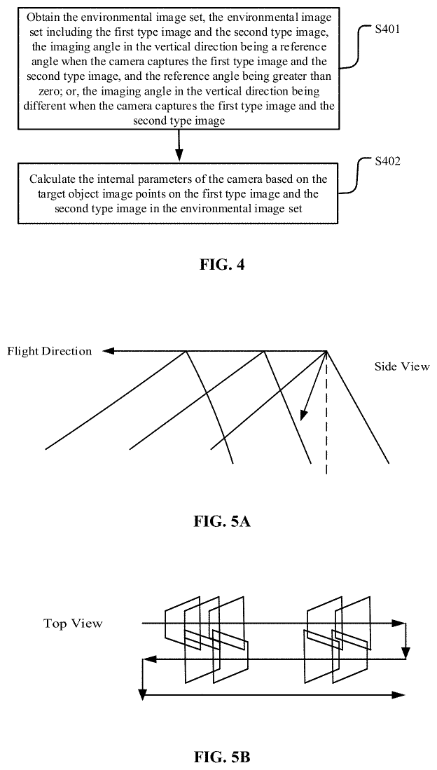

Referring to FIG. 4, which is another method for processing parameters of a camera according to an embodiment of the present disclosure. The parameter processing method for the camera shown in FIG. 4 can make the camera tilt a certain angle in the vertical direction when capturing the environmental images below the aircraft, thereby ensuring the accuracy of the calculate focal length of the camera. The method will be described in detail below.

S401, obtaining the environmental image set, the environmental image set including the first type image and the second type image, the imaging angle in the vertical direction being a reference angle when the camera captures the first type image and the second type image, and the reference angle being greater than zero; or the imaging angle in the vertical direction being different when the camera captures the first type image and the second type image.

S402, calculating the internal parameters of the camera based on the target object image points on the first type image and the second type image in the environmental image set.

When using the method shown in FIG. 4 to calculate the focal length of the camera, an environmental image set may be first obtained. The environmental image set may include a first type image and at least two second type images, where the imaging angle in the vertical direction when the camera captures the first type image and the second type images may be a reference angle, and the reference angle may be greater than 0°; or the imaging angle in the vertical direction may be different when the camera captures the first type image and the second type images. In some embodiments, the first type image and the second type image described here may be different from the first type image and the second type image in the embodiment shown in FIG. 2.

In some embodiments, the process at S401 may indicate that when the camera captures the environmental images below the aircraft, it is needed to ensure that the camera forms a certain angle with the vertical direction. If the first type image and the second type image are captured with the camera's imaging angle in the vertical direction remaining unchanged (i.e., the imaging angle of the camera in the vertical direction is constantly the reference angle), the reference angle may be any angle that is not equal to 0°. In some embodiments, the reference angle may be randomly selected or predetermined.

In some embodiments, if the camera is mounted on the aircraft through a gimbal, and if the camera has different imaging angles in the vertical direction when capturing the first type image and the second type image, the image processing device may control the rotation of the gimbal during the flight of the aircraft, such that the imaging angle of the camera in the vertical direction may be different before and after the gimbal is rotated. That is, during the flight of the aircraft, by controlling the rotation of the gimbal, the camera may have different imaging angles in the vertical direction when capturing the first type image and the second type image.

In some embodiments, the aircraft may fly based on a predetermined flight path, and the control of the gimbal rotation may be a control of the gimbal rotation on the target waypoint on the predetermined flight path. That is, when the aircraft flies to the target waypoint on the predetermined flight path, the gimbal can be controlled to rotate. In some embodiments, the target waypoint may be a pre-designated waypoint, that is, the target waypoint may be selected randomly on a predetermined flight path. Alternatively, the target way point may also be a waypoint determined from the predetermined flight path based on a predetermined confirmation rule.

In some embodiments, controlling the rotation of the gimbal on the target waypoint on the predetermined flight path may include controlling the gimbal to rotate based on a predetermined angle interval on the target waypoint. That is, an angle interval may be set in advance, such as 10°. When the aircraft flies to a target waypoint, the gimbal may be controlled to rotate 10° based on the current angle. In other embodiments, a number of target waypoints on the predetermined flight path may be first obtained, then a rotation angle may be set for each target waypoint. When a target waypoint is reached, the rotation angle corresponding to the target waypoint may be determined, and the gimbal may be controlled to rotate based on the rotation angle. Assume that the number of target waypoints on the predetermined flight path is two, the first rotation angle of the gimbal is set to 10°, and the send rotation angle of the gimbal is set to 20°. When the aircraft flies to the first target waypoint, it may determine that the rotation angle corresponding to the target waypoint is 10°, and the gimbal may be controlled to rotate 10° based on the current angle.

In some embodiments, the predetermined confirmation rule may be a distance interval, and determining the target waypoint on the predetermined flight path based on the predetermined confirmation rule may include setting each distance interval in advance; and setting a target waypoint on the flight path when each distance interval is reached. The distance interval may be a regular interval. For example, if the distance intervals are the same at 1000 meters, it means that a target waypoint can be set on the predetermined flight path every 1000 meters. In another example, the distance intervals may be different, and the gap between each distance interval may be an arithmetic series. For example, the first distance interval may be 500 meters, the second distance interval may be 1000 meters, and the third distance interval may be 1500 meters, and so on to set a plurality of distance intervals, and a target waypoint can be set at each distance interval. In one embodiment, the distance interval may be set irregularly. For example, the first distance interval may be 100 meters, the second distance interval may be 350 meters, and the third distance interval may be 860 meters, and so on. In another embodiment, in practical applications, the confirmation rule for setting the target waypoint may be determined based on the performance of the aircraft and the environment.

In another embodiment, the flight of the aircraft may be based on a predetermined flight path, and controlling the gimbal rotation may be controlling the gimbal rotation on the predetermined flight path at a predetermined time interval. In one embodiment, the implementation of controlling the rotation of the gimbal on the predetermined flight path based on the predetermined time interval may include setting the aircraft to control the gimbal to rotate once every 5 minutes during the flight of the predetermined flight path.

In another embodiment, controlling the rotation of the gimbal on the predetermined flight path based on the predetermined time interval may also include determining the number of times the aircraft needs to control the rotation of the gimbal during the flight of the predetermined flight path first; and setting a time interval for each rotation. In this way, when a certain time interval is reached, the gimbal can be controlled to rotate. For example, assume that it is determined that the aircraft needs to control the gimbal to rotate twice during the flight of the predetermined flight path, the time interval for controlling the gimbal rotation for the first time is 5 minutes, and the time for controlling the gimbal rotation for the second time is 30 minutes. That is, when the timing module on the aircraft detects that the aircraft has started flying for 5 minutes, it can control the gimbal to rotate once, and then the time module can be reset to restart the timing. When 30 minutes have passed since the first rotation of the gimbal, the gimbal can be controlled to rotate again.

In the parameter processing method shown in FIG. 4, after obtaining the first type image and the second type image, in the process at S402, the image processing device may calculate the internal parameters of the camera based on the target object image points on the first type image and the second type image in the environmental image set. The internal parameters of the camera described here may include the focal length of the camera.

In some embodiments, the implementation of the process at S402 may be the image processing device using an aerial triangulation algorithm to calculate the internal parameters of the camera based on the first type image and the second type image.

In some embodiments, when the camera captures the first type image and the second type image, if the imaging angles in the vertical direction is the same, then both imaging angles may be the reference angle and the reference may be 0°. At this time, when using the aerial triangulation algorithm to calculate the internal parameters of the camera, the focal length of the camera cannot be accurately determined, resulting in an elevation error in the generated orthophoto. If a wide-angle lens is used to make the camera's imaging direction at a certain angle with the vertical direction, as shown in the sides view of FIG. 5A and the top view of FIG. 5B, then the aerial triangulation algorithm can be used to calculate the accurate focal length of the camera based on the first type image and the second type image. Alternatively, in some other embodiments, when the camera captures the first type image and the second type image, if the imaging angles of the camera in the vertical direction is the same, then both imaging angles may be the reference angle, and the reference angle may not be equal to 0°. At this time, an accurate camera focal length may also be obtained based on the first type image and the second type image.

The following is an example to illustrate why an accurate camera focal length cannot be obtained when the camera is capturing the first type image and the second type image, the camera's imaging angles in the vertical direction is the same, and both imaging angles are the reference angle, and the reference angle is 0°; and why an accurate camera focal length cannot be obtained when the camera is capturing the first type image and the second type image, and the camera's imaging angle in the vertical direction is not the same.

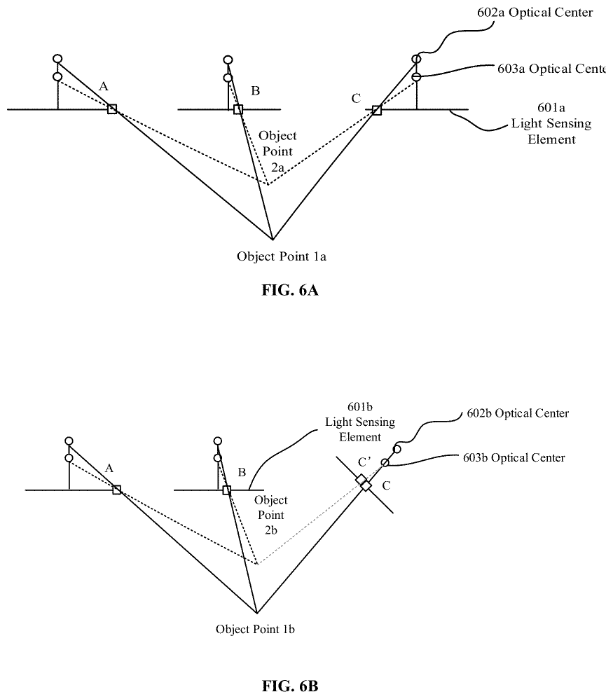

For example, FIG. 6A is a schematic diagram of calculating the focal length of the camera when the imaging angles in the vertical direction when capturing the first type image and the second type image is the reference angle and the reference angle is 0° according to an embodiment of the present disclosure. In FIG. 6A, 601a is a light sensing element, A and B are the target object image points on the second type image, and C is the target object image point on the first type image. The first type image and the second type image here may be the environmental images captured by the camera when the imaging angle of the camera is the vertical direction is 0°. If it is assumed that 602a is the optical center, the light path passing through the optical center 602a and the three target object image points intersect at the object point 1a, which conforms to the projection model of the camera, indicating that the optical center 602a can be the optical center of the camera, and the distance f from the optical center 602a to the light sensing element 601a can represent the focal length of the camera.

If 603a is assumed to be the optical center, it can be seen from FIG. 6B that the light path passing through the optical center 603a and the three target object image points can still intersect at the object point 2a, which also conforms to the projection model of the camera, indicating that the optical center 603a can also be the optical center of the camera, and the distance f′ from the optical center 603a to the light sensing element 601a can represent the focal length of the camera. It can be seen that if the camera imaging angles in the vertical direction when capturing the first type image and the second type image are both the reference angle, and the reference angle is 0°, at least two focal lengths of the camera can be obtained. As such, the correct focal length of the camera may not be accurately selected from the at least two focal lengths. If the incorrect focal length of the camera is selected, it will cause errors in the elevation in the orthophoto.

Referring to FIG. 6B, which is a schematic diagram of calculating the focal length of the camera when the imaging angles in the vertical direction are different when the first type image and the second type image are captured by the camera according to an embodiment of the present disclosure. In FIG. 6B, 601b is a light sensing element, A and B are the target object image points on the second type image, and C is the target object image point on the first type image. The environmental images may be the first type image and the second type image captured by the camera when the imaging angles in the vertical direction are different. For example, the first type image may be the environmental image captured when the camera's imaging angle in the vertical direction is 10°; and the second type image may be the environmental image captured when the camera's imaging angle in the vertical direction is 35°. If 602b is assumed to be the optical center, then the three light paths passing through the optical center 602b and the three target object image points can converge at the object point 1b, which conforms to the projection model of the camera, indicating that the 602b may be the optical center of the camera, and the distance between the optical center 602b and the light sensing element 601b can be used as the focal length f of the camera.

In FIG. 6B, assuming that 603b is the optical center, the two optical paths passing through the optical center 603b and the two target object image points on the second type image can intersect at the object point 2b. However, the object point 2b projected on the target image is C′, which is different from the target object image point on the first type image. This situation does not conform to the projection model of the camera, therefore, it can be determined that the optical center 603b is not the optical center of the camera. Similarly, the object points determined by the optical centers other than the optical center 602b may not satisfy the projection model of the camera, which will not be listed here. In summary, there is only one optical center 602b in FIG. 6B that satisfies the projection model, therefore, the distance f between the optical center 602b and the light sensing element can be used as the focal length of the camera.

In the embodiments of the present disclosure, when the camera is capturing the first type image and the second type image, the imaging angles of the camera in the vertical direction may be set to be different, which can avoid obtaining multiple focal lengths of the camera, and can more accurately determine the focal length of the camera, thereby improving the elevation accuracy of the orthophoto generated.

Through the actual measurement, if the parameter processing method of the camera shown in FIG. 2 is used to calculate the image position of the principal point of the camera, and the orthophoto is generated based on the image position of the principal point, the horizontal accuracy of the orthophoto can be increased by about 8 cm. That is, if the direction of the light sensing element used by the camera when capturing the first type image and the second type image is not the same, then based on the first type image and the second type image and using the aerial triangulation algorithm or the SFM algorithm, the image position of the principal point can be calculated. Subsequently, based on the image position of the principal point, the horizontal accuracy of the generated orthophoto can be increased by about 8 cm. If the parameter processing method of the camera shown in FIG. 4 is used to calculate the focal length of the camera, and the orthophoto is generated based on the focal length, the elevation accuracy of the orthophoto can be improved by about 2 cm. That is, if the camera's imaging angles in the vertical when capturing the first type image and the second type image are different, or the imaging angles are the same and not equal to 0°, then based on the first type image and the second type image and using the aerial triangulation algorithm or the SFM algorithm, the focal length of the camera can be obtained. Subsequently, based on the focal length, the horizontal accuracy of the generated orthophoto can be increased by about 8 cm

In practical applications, based on the accuracy requirements of the orthophoto, the camera parameter processing method shown in FIG. 2 or FIG. 4 can be selected to calculate the internal parameters of the camera, and then the orthophoto can be generated based on the internal parameters of the camera. If the accuracy in the horizontal direction is mainly required when using the orthophoto in practice, the parameter processing method of the camera shown in FIG. 2 can be used to generate the orthophoto. If the elevation accuracy is mainly required when using the orthophoto in practice, the parameter processing method of the camera shown in FIG. 4 can be used to generate the orthophoto.

In the embodiment shown in FIG. 4, a first type image and at least two second type image are selected from the environmental images captured by the camera to form an environmental image set. When the camera captures the first type image and the second type image, the imaging angle of the camera in the vertical direction may be different, or the imaging angle of the camera in the vertical direction may be a reference angle greater than 0°. After obtaining the environmental image set, the camera's internal parameters can be calculated based on the target object image points on the first type image and the second type images. Since the first type image and the second type images are captured with the camera in different imaging angles in the vertical direction or when the camera's imaging angles in the vertical direction are identical but not 0°, therefore, the situation of obtaining multiple focal lengths of the camera can be avoided, and an accurate focal length of the camera can be obtained, thereby improving the accuracy of the orthophoto in elevation.

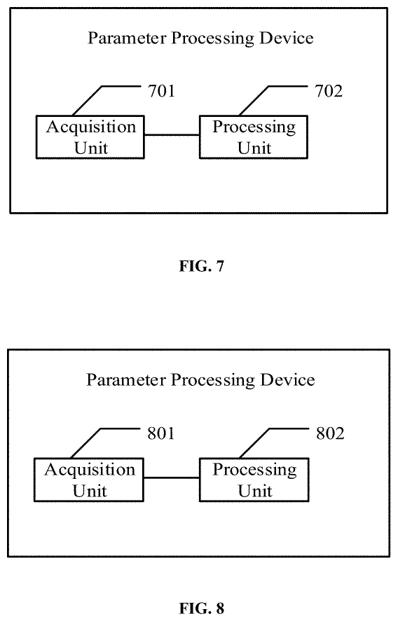

Based on the description of the above method embodiments, an embodiment of the present disclosure further provides a parameter processing device for a camera as shown in FIG. 7. The camera can be mounted on an aircraft, and the camera can be used to capture environmental images of the environment below the aircraft. The parameter processing device for the camera can be disposed in the camera or on the aircraft. The parameter processing device can include an acquisition unit 701 and a processing unit 702.

The acquisition unit 701 may be configured to obtain the environmental image set, where the environmental image set includes a first type image and at least two second type images, and the direction of the light sensing element used when the camera captures the first type image and the second type images are different.

The processing unit 702 may be configured to calculate the internal parameters of the camera based on the target object image points on the first type image and the second type images in the environmental image set.

In some embodiments, the calculated internal parameters may include the image position of the principal point of the camera.

In some embodiments, the camera may be mounted on the aircraft via a gimbal. The processing unit 702 may be further configured to control the rotation of the gimbal during the flight of the aircraft, such that the camera can use different light sensing element directions to capture environmental images before and after the rotation of the gimbal.

In some embodiments, the aircraft may be flying based on a predetermined flight path. The processing unit 702 controlling the rotation of the gimbal may include controlling the rotation of the gimbal on the target waypoints of the predetermined flight path.

In some embodiments, the target waypoints may include a plurality of designated waypoints on the predetermined flight path, or the target waypoints may include a plurality of waypoints determined from the predetermined flight path based on a predetermined confirmation rule.

In some embodiments, the aircraft may fly based on a predetermined flight path, and the processing unit 702 controlling the rotation of the gimbal may include controlling the rotation of the gimbal on the predetermined flight path based on a predetermined time interval.

In some embodiments, the camera may include a wide-angle lens. In some embodiments, the processing unit 702 calculating the internal parameters of the camera based on the target object image point on the first type image and the second type images in the environmental image set may include using an aerial triangulation algorithm to calculate the internal parameters of the camera.

In some embodiments, the processing unit 702 may be further configured to generate a digital surface model based on the calculated internal parameters of the camera and the captured environmental images.

Referring to FIG. 8, which is another parameter processing device for a camera provided by an embodiment of the present disclosure. The camera can be mounted on an aircraft, and the camera can be used to capture environmental images of the environment below the aircraft. The parameter processing device for the camera can be disposed in the camera or on the aircraft. The parameter processing device can include an acquisition unit 801 and a processing unit 802.

The acquisition unit 801 may be configured to obtain the environmental image set, where the environmental image set includes a first type image and at least two second type images. In some embodiments, the imaging angle in the vertical direction when the camera captures the first type image and the second type images may be a reference angle, and the reference angle may be greater than 0°; or the imaging angle in the vertical direction when the camera captures the first type image and the second type images may be different.

The processing unit 802 may be configured to calculate the internal parameters of the camera based on the target object image points on the first type image and the second type images in the environmental image set.

In some embodiments, the calculated internal parameters may include the focal length of the camera.

In some embodiments, when the camera captures the first type image and the second type images, the imaging angle in the vertical direction may be different, and the camera may be mounted on the aircraft through a gimbal. The processing unit 802 may be further configured to control the rotation of the gimbal during the flight of the aircraft, such that the camera can have different imaging angles in the vertical direction before and after the rotation of the gimbal.

In some embodiments, the aircraft may fly based on a predetermined flight path, and the processing unit 802 controlling the rotation of the gimbal may include controlling the rotation of the gimbal at the target waypoints on the predetermined flight path. In some embodiments, the target waypoints may include a plurality of designated waypoints on the predetermined flight path, or the target waypoints may include a plurality of waypoints determined from the predetermined flight path based on a predetermined confirmation rule.

In some embodiments, the aircraft may fly based on a predetermined flight path, and the processing unit 802 controlling the rotation of the gimbal may include controlling the rotation of the gimbal on the predetermined flight path based on a predetermined time interval.

In some embodiments, controlling the rotation of the gimbal on the target waypoints on the predetermined flight path may include controlling the rotation of the gimbal based on a predetermined angle interval on the target waypoints. In some embodiments, the camera may include a wide-angle lens.

In some embodiments, the processing unit 802 calculating the internal parameters of the camera based on the target object image point on the first type image and the second type images in the environmental image set may include using an aerial triangulation algorithm to calculate the internal parameters of the camera.

In some embodiments, the processing unit 802 may be further configured to generate a digital surface model based on the calculated internal parameters of the camera and the captured environmental images.

Referring to FIG. 9, which is a schematic structure diagram of an image processing device according to an embodiment of the present disclosure. The image processing device shown in FIG. 9 can be used to process the parameters of a camera. The camera can be mounted on an aircraft, and the camera can be used to capture environmental images of the environment below the aircraft. The image processing device can include a processor 901 and a memory 902. The processor 901 and the memory 902 can be connected through a bus 903, and the memory 902 can be used to store program instructions.

The memory 902 may include a volatile memory, such as a random-access memory (RAM). The memory 902 may also include a non-volatile memory, such as a flash memory, a solid-state drive (SSD), etc. The memory 902 may also include a combination of the foregoing types of memories.

The processor 901 may be a central processing unit (CPU). The processor 901 may further include a hardware chip. The foregoing hardware chip may be an application-specific integrated circuit (ASIC), a programmable logic device (PLD), etc. The PLD may be a field-programmable gate array (FPGA), a generic array logic (GAL), etc. The processor 901 may also be a combination of the foregoing structures.

In the embodiments of the present disclosure, the processor can be used to execute the program instructions stored in the memory 902 to implement the corresponding method in the embodiment shown in FIG. 2. When executed by the processor 901, the program instructions can cause the processor 901 to obtain the environmental image set, where the environmental image set includes a first type image and at least two second type images, and the direction of the light sensing element used when the camera captures the first type image and the second type images are different; and calculate the internal parameters of the camera based on the target object image points on the first type image and the second type images in the environmental image set. In some embodiments, the calculated internal parameters may include the image position of the principal point of the camera.

In some embodiments, the camera may be mounted on the aircraft via a gimbal. When executed by the processor 901, the program instructions can cause the processor 901 to control the rotation of the gimbal during the flight of the aircraft, such that the camera can use different light sensing element directions to capture environmental images before and after the rotation of the gimbal.

In some embodiments, the aircraft may fly based on a predetermined flight path. When controlling the rotation of the gimbal, the program instructions can cause the processor 901 to control the rotation of the gimbal on the target waypoints of the predetermined flight path. In some embodiments, the target waypoints may include a plurality of designated waypoints on the predetermined flight path, or the target waypoints may include a plurality of waypoints determined from the predetermined flight path based on a predetermined confirmation rule.

In some embodiments, the aircraft may fly based on a predetermined flight path. When controlling the rotation of the gimbal, the program instructions can cause the processor 901 to control the rotation of the gimbal on the predetermined flight path based on a predetermined time interval.

In some embodiments, the camera may include a wide-angle lens. When executed by the processor 901, the program instructions can cause the processor 901 to use an aerial triangulation algorithm to calculate the internal parameters of the camera.

In some embodiments, when executed by the processor 901, the program instructions can further cause the processor 901 generate a digital surface model based on the calculated internal parameters of the camera and the captured environmental images.

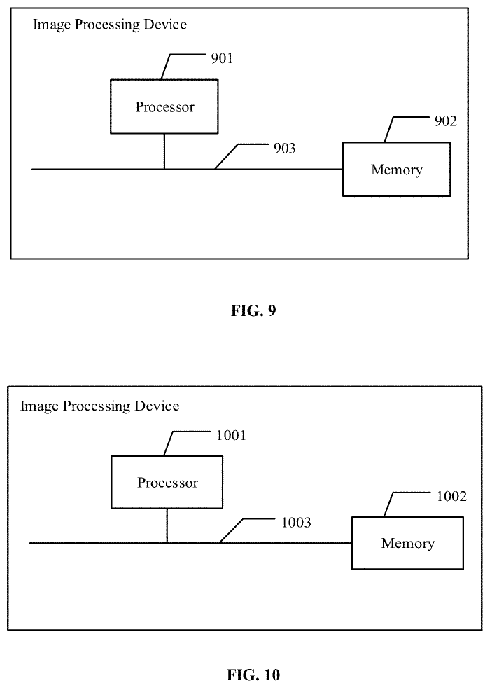

Referring to FIG. 10, which is a schematic structure diagram of another image processing device according to an embodiment of the present disclosure. The image processing device shown in FIG. 10 can be used to process the parameters of a camera. The camera can be mounted on an aircraft, and the camera can be used to capture environmental images of the environment below the aircraft. The image processing device can include a processor 1001 and a memory 1002. The processor 1001 and the memory 1002 can be connected through a bus 1003, and the memory 1002 can be used to store program instructions.

The memory 1002 may include a volatile memory, such as a random-access memory (RAM). The memory 1002 may also include a non-volatile memory, such as a flash memory, a solid-state drive (SSD), etc. The memory 1002 may also include a combination of the foregoing types of memories.

The processor 1001 may be a central processing unit (CPU). The processor 1001 may further include a hardware chip. The foregoing hardware chip may be an application-specific integrated circuit (ASIC), a programmable logic device (PLD), etc. The PLD may be a field-programmable gate array (FPGA), a generic array logic (GAL), etc. The processor 1001 may also be a combination of the foregoing structures.

In the embodiments of the present disclosure, the memory 1002 can be used to store computer instructions, and the processor can be used to execute the program instructions stored in the memory 1002 to implement the corresponding method in the embodiment shown in FIG. 4.

In the embodiments of the present disclosure, the processor can be used to execute the program instructions stored in the memory 1002 to implement the corresponding method in the embodiment shown in FIG. 4. When executed by the processor 1001, the program instructions can cause the processor 1001 to obtain the environmental image set, where the environmental image set includes a first type image and at least two second type images. In some embodiments, the imaging angle in the vertical direction when the camera captures the first type image and the second type images may be a reference angle, and the reference angle may be greater than 0°; or, the imaging angle in the vertical direction when the camera captures the first type image and the second type images may be different; and calculate the internal parameters of the camera based on the target object image points on the first type image and the second type images in the environmental image set. In some embodiments, the calculated internal parameters may include the focal length of the camera.

In some embodiments, when the camera captures the first type image and the second type images, the imaging angle in the vertical direction may be different, and the camera may be mounted on the aircraft through a gimbal. When executed by the processor 1001, the program instructions can further cause the processor 1001 to control the rotation of the gimbal during the flight of the aircraft, such that the camera can have different imaging angles in the vertical direction before and after the rotation of the gimbal.

In some embodiments, the aircraft may fly based on a predetermined flight path. When controlling the rotation of the gimbal, the program instructions can cause the processor 1001 to control the rotation of the gimbal at the target waypoints on the predetermined flight path. In some embodiments, the target waypoints may include a plurality of designated waypoints on the predetermined flight path, or the target waypoints may include a plurality of waypoints determined from the predetermined flight path based on a predetermined confirmation rule.

In some embodiments, the aircraft may fly based on a predetermined flight path. When controlling the rotation of the gimbal, the program instructions can cause the processor 1001 to control the rotation of the gimbal on the predetermined flight path based on a predetermined time interval.

In some embodiments, when controlling the rotation of the gimbal on the target waypoints on the predetermined flight path, the program instructions can cause the processor 1001 to control the rotation of the gimbal on the target waypoint based on a predetermined angle interval.

In some embodiments, the camera may include a wide-angle lens. When executed by the processor 1001, the program instructions can cause the processor 1001 to use an aerial triangulation algorithm to calculate the internal parameters of the camera. In some embodiments, when executed by the processor 1001, the program instructions can cause the processor 1001 to generate a digital surface model based on the calculated internal parameters of the camera and he captured environmental images.

Those skilled in the art shall understand that all or parts of the steps in the above exemplifying method for the present disclosure may be achieved by commanding the related hardware with programs, the programs may be stored in a computer-readable storage medium, and the programs comprise one or a combination of the steps in the method embodiments of the present disclosure when running on a computer. In some embodiments, the storage medium may be a magnetic disk, an optical disk, a read-only memory (ROM), or a random access memory (RAM).

The above descriptions only illustrate some embodiments of the present disclosure. The present disclosure is not limited the described embodiments. A person having ordinary skill in the art may conceive various equivalent modifications or replacements based on the disclosed technology. Such modification or improvement also fall within the scope of the present disclosure. A true scope and spirit of the present disclosure are indicated by the following claims.

What is claimed is:

1. A method for processing camera parameters, comprising:
obtaining an environmental image set, the environmental image set including a first type image and two or more second type images, a direction of a light sensing element of the camera capturing the first type image being different from the direction of the light sensing element of the camera capturing the two or more second type images;
calculating internal parameters of the camera based on a plurality of target object image points on the first type image and the two or more second type images in the environmental image set, wherein
the camera is mounted on an aircraft, the camera is configured to capture a plurality of environmental images of an environment below the aircraft, and the calculated internal parameters of the camera include an image position of the principal point of the camera.

2. The method of claim 1, wherein:
the camera is mounted on the aircraft via a gimbal; and
the method further includes:
controlling the gimbal to rotate during a flight of the aircraft for the camera capturing the plurality of environmental images using different directions of the light sensing element before and after the rotation of the gimbal.

3. The method of claim 2, wherein:
the aircraft is flying based on a predetermined flight path; and
controlling the rotation of the gimbal includes controlling the rotation of the gimbal on a plurality of target waypoints on the predetermined flight path.

4. The method of claim 3, wherein:
the plurality of target waypoints include a plurality of designated waypoints on the predetermined flight path; or, the plurality of target waypoints include a plurality of waypoints determined from the predetermined flight path based on a predetermined confirmation rule.

5. The method of claim 2, wherein:
the aircraft is flying based on a predetermined flight path; and
controlling the rotation of the gimbal includes controlling the rotation of the gimbal on the predetermined flight path based on a predetermined time interval.

6. The method of claim 1, wherein:
the camera includes a wide-angle lens.

7. The method of claim 1, wherein:
an aerial triangulation algorithm is used to calculate the internal parameters of the camera.

8. The method of claim 1, further comprising:
generating a digital surface model based on the calculated internal parameters of the camera and the plurality of captured environmental images.

9. An image processing device, comprising:
a processor; and
a memory storing program instructions that, when being executed by the processor, cause the processor to
obtain an environmental image set, the environmental image set including a first type image and two or more second type images, a direction of a light sensing element of the camera capturing the first type image being different from the direction of the light sensing element of the camera capturing the two or more second type images;
calculate internal parameters of the camera based on a plurality of target object image points on the first type image and the two or more second type images in the environmental image set, wherein
the image processing device is configured to process the parameters of the camera, the camera is mounted on the aircraft and configured to capture a plurality of environmental images on an environment below the aircraft, and the calculated internal parameters include a focal length of the camera.

10. The image processing device of claim 9, wherein:
the camera is mounted on the aircraft via a gimbal; and
the program instructions further cause the processor to control the gimbal to rotate during a flight of the aircraft for the camera capturing the plurality of environmental images using different directions of the light sensing element before and after the rotation of the gimbal

11. The image processing device of claim 10, wherein:
the aircraft flies based on a predetermined flight path; and
the processor controlling the rotation of the gimbal includes controlling the rotation of the gimbal on a plurality of target waypoints on the predetermined flight path.

12. The image processing device of claim 11, wherein:
the plurality of target waypoints include a plurality of designated waypoints on the predetermined flight path; or, the plurality of target waypoints include a plurality of waypoints determined from the predetermined flight path based on a predetermined confirmation rule.

13. The image processing device of claim 10, wherein:
the aircraft flies based on a predetermined flight path; and
the processor controlling the rotation of the gimbal includes controlling the rotation of the gimbal on the predetermined flight path based on a predetermined time interval.

14. The image processing device of claim 9, wherein:
the camera includes a wide-angle lens.

15. The image processing device of claim 9, wherein the program instructions further cause the processor to:
use an aerial triangulation algorithm to calculate the internal parameters of the camera.

16. The image processing device of claim 9, wherein the program instructions further cause the processor to:
generate a digital surface model based on the calculated internal parameters of the camera and the plurality of captured environmental images.
